(19) United States
(12) Patent Application Publication
(10) Pub. No.: US 2011/0238267 A1
(43) Pub. Date: Sep. 29, 2011

(54) METHOD FOR ADJUSTING A BRAKE SYSTEM OF A VEHICLE

(76) Inventor: Ferah Cetinkaya, Ilsfeld (DE)

(21) Appl. No.: 12/998,360

(22) PCT Filed: Aug. 26, 2009
(86) PCT No.: PCT/EP2009/060988

§ 371 Date: Jun. 16, 2011

(30) Foreign Application Priority Data
Oct. 20, 2008 (DE) 10 2008 042 968.6

(51) Int. Cl. B60T 7/22; G06F 7/00

(52) U.S. Cl. 701/48; 701/83

(57) ABSTRACT

In a method for adjusting a brake system of a vehicle, braking power is automatically built up in the event of a collision. In the event of a collision, at least one foot pedal to be actuated by the driver is moved from its regular operating position, in which the foot pedal projects into the foot space, to an inoperative position in which the foot pedal is at least partially removed from the foot space.

### BACKGROUND OF THE INVENTION

1. Field of the Invention

The present invention relates to a method for adjusting a brake system.

2. Description of Related Art

A method is described in published German patent document 197 53 971 A1 for controlling a brake system of a vehicle, in which in the event of a collision with another vehicle, braking power is built up at the wheel brakes which is greater than the braking power specified by the driver by actuating the brake pedal and/or a parking brake. As a result of the automatic buildup of the braking power, in the event of collisions the aim is to reduce the severity of the accident or prevent a consequential accident. The additional braking power ensures that the vehicle remains at a standstill, or at least is brought to a standstill more quickly.

The automatic buildup of the braking power in the event of a collision may be overridden, i.e., terminated, by a response of the driver, for example as the result of the driver actuating the accelerator pedal after an automatic buildup of braking power has taken place.

By overriding the automatic buildup of braking power as the result of an appropriate driver response, the driver regains exclusive control over the actuation and regains control of the vehicle. However, it must be taken into account that, the driver is also able to deactivate the automatic buildup of braking power by panic responses, even when this results in a more hazardous traffic situation than if the automatic generation of braking power were continued.

### BRIEF SUMMARY OF THE INVENTION

An object of the present invention is to further increase the safety in a vehicle by automatic buildup of braking power in the event of a collision.

In the method according to the present invention for adjusting a brake system of a vehicle, braking power is automatically built up in the event of a collision. The brake system may be designed as a hydraulic brake, an electrohydraulic brake, an electric motor brake, or possibly an electropneumatic brake, and is adjusted via actuating signals of an associated regulation and control device, it being possible to process information from a sensor system of the vehicle, for example signals of radar-assisted sensors, LIDAR sensors, ultrasonic sensors, or optical sensors, in the regulation and control device. Also considered is processing of signals of sensors, via which the longitudinal and/or transverse dynamic driving state of the vehicle is/are detected, for example the vehicle longitudinal speed, the vehicle longitudinal acceleration, the lateral acceleration, the yaw rate, or the wheel slip. Lastly, information from an airbag control device may also be processed in the regulation and control device which indicates whether one or multiple airbags in the vehicle have been deployed. The deployment of an airbag may be sufficient to identify a collision, whereupon the braking power is automatically built up via the regulation and control device. However, it is also possible to identify the collision via the environmental sensor system or the state variable sensor system, and optionally, also shortly before a collision occurs, braking power may be built up. It is also possible for the manner of the braking power buildup to be made a function of the received signals, in particular with regard to the exact point in time of the braking power buildup, at which a time delay may optionally be introduced as dead time, with regard to the gradient for the buildup of the braking power, and with regard to the maximum braking power level to be achieved.

To further increase the driver safety, in the event of a collision, in addition to the automatic buildup of braking power, at least one foot pedal is moved from the regular operating position, in which the foot pedal projects into the foot space, to an inoperative position in which the foot pedal is at least partially removed from the foot space. This adjustment of the foot pedal is also carried out automatically, and is linked to the occurrence or the imminence of a collision. To allow the adjustment to be carried out, the vehicle is advantageously provided with means, in particular an actuator, which are/is able to actively adjust the position of the foot pedal in the intended manner. A passive system may also optionally be considered, in which the adjustment motion of the foot pedal is deduced from another adjustment motion which is internal to the vehicle, for example on the basis of the deformation of the vehicle front end region.

To ensure that panic responses of the driver do not result in a termination of the automatic generation of braking power, according to one advantageous refinement it is provided that in the event of an adjustment of the at least one foot pedal to the inoperative position, it is not possible for the automatic generation of braking power to be deactivated by a driver response. In this situation the otherwise applicable principle, that the driver is able to override, i.e., deactivate, an automatic intervention of a regulation and control system in the vehicle dynamics by an appropriate response, is suspended.

In the event of a collision and a retraction of the foot pedal, there is the risk that the driver, as the result of a panic response, may carry out an incorrect actuation which would result in a more hazardous situation which is estimated to be more severe than the autonomy, i.e., driving control, of the driver over the vehicle.

It may be advantageous for the deactivation of the driver override to be linked to the severity of the collision. In this case, for less severe collisions the foot pedal is advantageously not adjusted, and instead remains in its operating position in which it projects into the foot space, at the same time braking power being automatically built up. In this situation the driver has the option to terminate the automatic buildup of braking power via an appropriate response. Only beyond a certain severity of the collision is the foot pedal also moved from the operating position, in which it projects into the foot space, to the inoperative position in which the foot pedal does not project, or only partially projects, into the foot space. Braking power is likewise automatically built up for these more severe collisions, it no longer being possible for this braking power buildup to be overridden by a driver response, as described above.

Various sensor data may be used to assess the severity of the collision. According to one easily implemented embodiment, it is possible to make a query as to whether one or multiple airbags have been deployed; if this is not the case, a less severe collision may be assumed, even when other data, such as signals of the environmental sensor system or the state variable sensor system, for example, indicate that a collision is imminent or has actually already occurred. On the other hand, if at least one airbag has deployed, a severe collision is assumed, in which case the at least one foot pedal is moved to the inoperative position, and braking power is also automatically built up which also is not deactivatable by a driver response.

The foot pedal, which in the event of collisions is moved from the operating position to the inoperative position in which the foot pedal is at least partially, optionally completely, removed from the foot space, is the accelerator pedal, the brake pedal, and/or the clutch pedal, provided that a clutch pedal is present.

### BRIEF DESCRIPTION OF THE DRAWINGS

FIG. 1 shows a schematic illustration of a motor vehicle which is provided with front and rear braking devices, and with a regulation and control device for adjusting the braking devices.

FIG. 2 shows in a block diagram the cooperation of various regulation and control devices and the brake system in the vehicle.

### DETAILED DESCRIPTION OF THE INVENTION

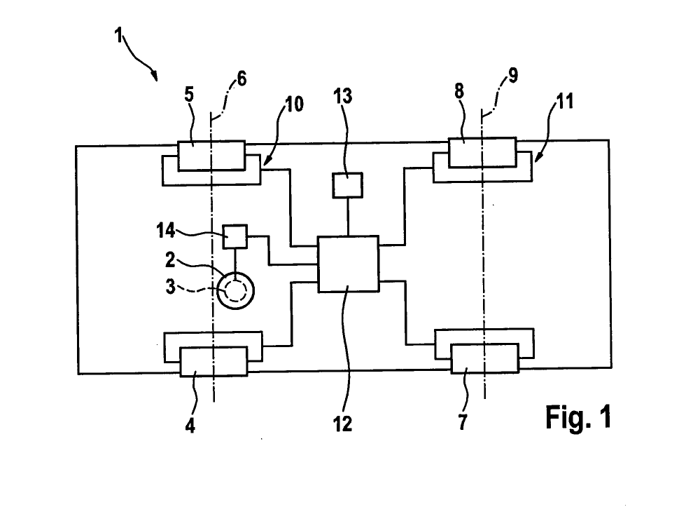

Motor vehicle 1 illustrated in FIG. 1 is controlled via a steering handle designed as a steering wheel 2, an airbag 3, which is associated with an airbag control device 14, being integrated into steering wheel 2. Motor vehicle 1 is provided with a brake system which includes a front braking device 10 and a rear braking device 11, the brake units of front braking device 10 acting on front wheels 4 and 5 which are rotatably supported on front axle 6, and the brake units of rear braking device 11 acting on rear wheels 7 and 8 which are rotatably supported on rear axle 9. The brake units of front braking device 10 and of rear braking device 11 may be designed as hydraulic brakes, electrohydraulic brakes, or electric motor brakes, it being possible for the type of brake for front and rear braking devices 10 and 11, respectively, to differ from one another. Braking devices 10 and 11 are adjusted via actuating signals of a regulation and control device 12, which may be an ESP control device. Regulation and control device 12 is connected to airbag control device 14 via data lines, which are preferably designed as a CAN bus, and is also connected to a sensor system 13 which transmits sensor signals to regulation and control device 12. Sensor system 13 is a state sensor system via which the vehicle state variables of the longitudinal and/or transverse dynamics may be ascertained, for example the vehicle longitudinal speed, the longitudinal acceleration, the lateral acceleration, the yaw rate, or the wheel slip. Alternatively or additionally, sensor system 13 includes an environmental sensor system via which the surroundings of motor vehicle 1 may be detected, for example the distance and the relative speed with respect to a preceding vehicle. The environmental sensor system includes radar-assisted sensors, LIDAR sensors, optical sensors, or ultrasonic sensors, for example.

In addition to steering wheel airbag 3, further airbags may optionally be provided in the vehicle which likewise are deployed via airbag control device 14.

In the event of a collision of motor vehicle 1 with another vehicle or some other object, braking power is automatically, i.e., independently, built up via the braking devices of the vehicle in order to reduce the severity of the consequences of an accident. In principle, braking power is automatically built up independently of an actuation of the brake pedal by the driver, although in certain situations the driver has the option, via his own responses, to suppress or terminate the automatic buildup of braking power. The automatic buildup of the braking power results in automatic braking of the vehicle, even without a braking response of the driver, thus providing additional safety. Various braking strategies may be implemented as a function of the accident situation at the moment, in particular with regard to a delayed buildup of automatic braking power (dead time), with regard to the gradient of the braking power buildup, as well as the maximum level of the braking power to be achieved.

Additional braking power may automatically be built up also in the event of an actuation of the brake pedal by the driver, in particular for the situation in which the braking power generated by the driver is less than what is appropriate for the situation at that moment. On the other hand, if the braking power generated by the driver is sufficient, no additional braking power is built up.

In order for the driver to maintain control over the vehicle, at least in certain accident situations, it is provided that the driver may override the automatic buildup of braking power, so that the automatic buildup of braking power is terminated or suppressed. This is carried out according to the present invention in accident situations involving a relatively minor collision. As a measure of the severity of the accident, the information is used, for example, concerning whether the foot pedals in the motor vehicle, in particular the brake pedal, the accelerator pedal, and the clutch pedal, if applicable, have been moved from the regular operating position, in which the foot pedal projects into the foot space, to an inoperative position, in which the foot pedal is at least partially retracted from the foot space, via active or passive safety measures in the vehicle. This adjustment of the pedals is preferably carried out only for relatively severe collisions, whereas for less severe collisions the pedals may remain in the foot space in the regular operating position.

The adjustment of the foot pedals depends on whether or not the automatic buildup of braking power may be terminated or suppressed by a response of the driver. For only minor collisions, which may be identified via the sensor system of the vehicle, for example, but which are not sufficient for an adjustment of the foot pedals, the driver may override, and therefore terminate or suppress, the automatic buildup of braking power via a response, for example an independent forceful actuation of the brake pedal. However, for more severe collisions in which the foot pedals are also retracted from the foot space, it is not possible to terminate the automatic buildup of braking power via a response of the driver. In this case, the risk that a corresponding driver response is based on a panic response outweighs the advantage of an independent determination of the vehicle dynamics by the driver. Instead, additional vehicle safety is achieved by braking the vehicle via the automatic buildup of braking power, even when the driver is exhibiting panic responses.

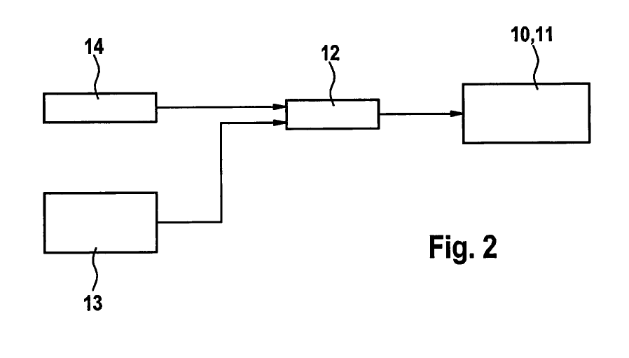

As illustrated in FIG. 2, airbag control device 14 and sensor system 13 communicate with regulation and control device 12, which generates actuating signals for adjusting braking devices 10 and 11. In this manner, the automatic buildup of braking power is made possible on the basis of the information, used as received signals, from airbag control device 14 and sensor system 13. At the same time, in the event of less severe collisions it is possible to terminate the automatic buildup of braking power, since the appropriate driver responses via which the automatic buildup of braking power may be overridden may be transmitted by sensor system 13. For this purpose, sensor system 13 may also include sensors which detect the instantaneous position of the foot pedals or the steering wheel.

1-11. (canceled)

12. A method for adjusting a brake system of a vehicle, comprising:
moving, in the event of a severe collision, at least one foot pedal of the vehicle from a regular operating position in which the foot pedal projects into a foot space, to an inoperative position in which the foot pedal is at least partially removed from the foot space; and
automatically building up a braking power of the brake system in the event of a collision, wherein at least one of (a) the automatic build up of the braking power and (b) maintaining of the built up braking power occurs during the moving of the at least one foot pedal.

13. The method as recited in claim 12, wherein in the event of moving of the at least one foot pedal to the inoperative position, the at least one of (a) the automatic build up of the braking power and (b) maintaining of the built up braking power occurs is not affected by a response of a driver of the vehicle.

14. The method as recited in claim 13, wherein a determination of an occurrence of a severe collision is based on deployment of an airbag in the vehicle.

15. The method as recited in claim 13, wherein a determination of an occurrence of a sever collision is based on sensor signals representing at least one of a longitudinal dynamic state variable and a transverse dynamic state variable.

16. The method as recited in claim 13, wherein for a non-severe collision the at least one foot pedal remains in the regular operating position, and the braking power of the brake system is automatically built up.

17. The method as recited in claim 16, wherein the automatically built up braking power is adapted to be deactivated by a response of the driver.

18. The method as recited in claim 17, wherein the severity of the collision is determined on the basis of deployment of an airbag in the vehicle.

19. A control device for adjusting a brake system of a vehicle, comprising:
a control unit for moving, in the event of a severe collision, at least one foot pedal of the vehicle from a regular operating position in which the foot pedal projects into a foot space, to an inoperative position in which the foot pedal is at least partially removed from the foot space; and
a control unit for automatically building up a braking power of the brake system in the event of a collision, wherein at least one of (a) the automatic build up of the braking power and (b) maintaining of the built up braking power occurs during the moving of the at least one foot pedal.

20. A brake system, comprising:
a foot pedal;
at least one wheel brake operationally linked to the foot pedal; and
a control unit configured to:
(i) move, in the event of a severe collision, at least one foot pedal of the vehicle from a regular operating position in which the foot pedal projects into a foot space, to an inoperative position in which the foot pedal is at least partially removed from the foot space; and
(ii) automatically build up a braking power of the brake system in the event of a collision, wherein at least one of (a) the automatic build up of the braking power and (b) maintaining of the built up braking power occurs during the moving of the at least one foot pedal.

21. The brake system as recited in claim 20, wherein the braking power is automatically built up as a function of actuating signals of an ESP control device.
